(19) United States
(12) Patent Application Publication
(10) Pub. No.: US 2018/0352104 A1
(43) Pub. Date: Dec. 6, 2018

(54) METHOD FOR CREATING GARBLED PDF TEXT

(71) Applicant: FUJIAN FOXIT SOFTWARE DEVELOPMENT JOINT STOCK CO., LTD., Fuzhou, Fujian (CN)

(72) Inventor: Qinggong Meng, Beijing (CN)

(21) Appl. No.: 15/779,905

(22) PCT Filed: Nov. 8, 2016
(86) PCT No.: PCT/CN2016/000619

§ 371 Date: May 30, 2018

(30) Foreign Application Priority Data
Dec. 3, 2015 (CN) 201510881153.6

(51) Int. Cl. H04N 1/00; G06F 21/10; G06F 17/22; G06F 21/60

(52) U.S. Cl. CPC H04N 1/00838; G06F 21/10; G06F 2221/2107; G06F 21/60; G06F 17/2217

(57) ABSTRACT

A method for creating a garbled PDF text comprises the following steps: upon creating a PDF document or saving the PDF document as a new document, embedding a PDF font in the created or newly saved PDF document (S110); using a random encoding method to change an embedded PDF font code such that it maps to a Unicode dictionary (S120); and converting codes in text content of the PDF document into random codes (S130).

### TECHNICAL FIELD

The present disclosure relates to a technical field of copyright protection, and in particular, to a technical field of a method for creating a garbled PDF text.

### BACKGROUND

PDF documents are at an end of an entire industrial process for creating, editing, protecting, publishing, circulating, and saving documents. Lots of electronic documents are circulated over the Internet in the form of PDF, and it is an urgent problem to be solved how to protect the rights and interests of the authors of PDF documents.

Currently, a PDF permission encryption method is a popular approach for protecting the rights and interests of the authors of the PDF documents. A reading party is allowed to share a content of a PDF document in a limited permission way by using a PDF permission encryption method to encrypt the document by setting a password or in another way. However, in this way, absolute security of the PDF document cannot guaranteed. Once the PDF document is decrypted, the content of the PDF document, especially text content and layout, can be copied and edited casually.

### SUMMARY OF THE INVENTION

The present disclosure provides a method for creating a garbled PDF text, for ensuring that users can share some of their PDF documents over the Internet without any step of encryption and stealers cannot find Unicode code(s) of a text content of the PDF documents from a font library.

To achieve the foregoing objective, the present disclosure provides a method for creating a garbled PDF text, including the following steps:

when a PDF document is created, or the PDF document is newly saved as a new document, embedding a PDF font(s) in the created or newly saved PDF document;

changing a ToUnicode mapping dictionary for codes of the embedded PDF font(s), by random encoding; and

converting codes for a text content of the PDF document into random codes according to the changed ToUnicode mapping dictionary.

Further, the random codes are meaningless scrambled numerical codes.

According to the present disclosure, after a character-font mapping relationship is changed, a PDF text can still be displayed as usual, although it cannot be normally mapped to a Unicode code. Users have to construct Unicode codes if stealing PDF content by using a computer (operations such as copying and cutting). Therefore, business costs may increase greatly. By using a technology of the present disclosure, the users can share some of their documents over the Internet without any step of encryption.

### BRIEF DESCRIPTION OF THE DRAWINGS

To illustrate the technical solution in embodiments of the present disclosure or in the prior art more clearly, the accompanying drawings for describing the embodiments or the prior art are introduced briefly in the following. Obviously, the accompanying drawings in the following description are only some embodiments of the present disclosure. Persons of ordinary skill in the art can obtain other drawings according to the accompanying drawings without paying any creative efforts.

FIG. 1 is a flowchart of a method for creating a garbled PDF text according to an embodiment of the present application.

### DETAILED DESCRIPTION OF THE EMBODIMENTS

The technical solutions in the embodiments of the present disclosure will be clearly and fully described below with reference to the accompanying drawings in the embodiments of the present disclosure. It is obvious that the embodiments to be described are only a part rather than all of the embodiments of the present disclosure. All other embodiments derived by persons of ordinary skill in the art based on the embodiments of the present disclosure without making creative efforts should fall within the protection scope of the present disclosure.

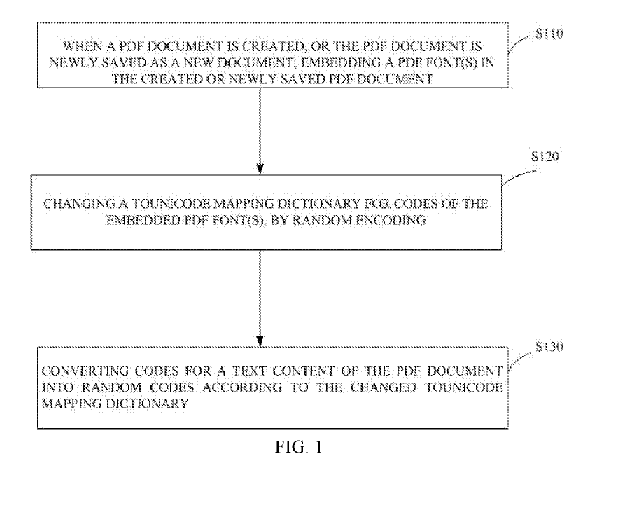

FIG. 1 is a flowchart of a method for creating a garbled PDF text according to an embodiment of the present application. As shown in FIG. 1, the method for creating a garbled PDF text includes the following steps:

S110. when a PDF document is created, or the PDF document is newly saved as a new document, embedding a PDF font(s) in the created or newly saved PDF document;

S120. changing a ToUnicode mapping dictionary for codes of the embedded PDF font(s), by random encoding; and

S130. converting codes for a text content of the PDF document into random codes according to the changed ToUnicode mapping dictionary.

For example, the random codes may be meaningless scrambled numerical codes. In this way, by means of changing code mapping in a font library, stealers cannot find a Unicode code of a text content of the document from the font library, and can only find meaningless internal codes such as 01 and 02.

A specific process according to a preferred embodiment of the present disclosure is as follows:

1. when a PDF document is created, or is newly saved as a new document, embedding a PDF font(s).

2. changing a ToUnicode mapping dictionary for codes of the embedded PDF font(s), by random encoding.

3. converting codes for a text content of the PDF document into random codes.

In the foregoing embodiment, after a character-font mapping relationship is changed, a PDF text can still be displayed as usual, although it cannot be normally mapped to a Unicode code. Users have to construct Unicode codes if stealing PDF content by using a computer (operations such as copy and cut). Therefore, business costs may increase greatly. The present disclosure is aimed at further protecting text content of PDF documents and increasing the difficulty in maliciously copying and commercially stealing texts of the PDF documents. By using a technology of the present disclosure, the users can share some of their documents over the Internet without any step of encryption.

Persons skilled in the art may understand that a drawing is merely a schematic diagram of an embodiment, and a module or procedure in the drawing is not necessarily mandatory to implement the present disclosure.

Persons of ordinary skill in the art may understand that modules in an apparatus in an embodiment may be distributed in the apparatus in the embodiment according to embodiment description, and may also be correspondingly changed and located in one or more apparatuses different from that in the embodiment. The modules in the embodiment may be combined into one module, and may also be divided into a plurality of submodules.

Finally, it should be noted that the above embodiment is merely provided for describing the technical solution of the present disclosure, but not intended to limit the present disclosure. It should be understood by persons of ordinary skill in the art that although the present disclosure has been described in detail with reference to the foregoing embodiment, modifications can be made to the technical solution described in the foregoing embodiment, or equivalent replacements can be made to some technical features in the technical solution, as long as such modifications or replacements do not cause the essence of the corresponding technical solution to depart from the spirit and scope of the technical solution in the embodiment of the present disclosure.

1. A method for creating a garbled PDF text, comprising the following steps:
when a PDF document is created, or the PDF document is newly saved as a new document, embedding a PDF font(s) in the created or newly saved PDF document;
changing a ToUnicode mapping dictionary for codes of the embedded PDF font(s), by random encoding; and
converting codes for a text content of the PDF document into random codes according to the changed ToUnicode mapping dictionary.

2. The method for creating a garbled PDF text according to claim 1, wherein the random codes are meaningless scrambled numerical codes.
